(19) United States
(12) Patent Application Publication
(10) Pub. No.: US 2007/0040402 A1
(43) Pub. Date: Feb. 22, 2007

(54) Mobile Workstation

(76) Inventor: Jonathan Alan Bork, Redmond, WA (US)

Correspondence Address: PATWRITE LLC, 408 W. MAIN ST., MARSHALLTOWN, IA, 50158-5759, US

(21) Appl. No.: 11/465,103

(22) Filed: Aug. 16, 2006

Related U.S. Application Data
(60) Provisional application No. 60/595,903, filed on Aug. 16, 2005.

(51) Int. Cl. B60R 9/00

(52) U.S. Cl. 296/37.6

(57) ABSTRACT

The present invention is a mobile workstation that is attached to a vehicle such as a pickup truck or SUV. The mobile workstation includes a hinged cover that closes over an inner containment area that is rotatably attached to extruded metal attachment members that can be attached to the vehicle using ratcheting tie-downs. In one embodiment, an attachment platform is attached to the metal attachment members to provide additional stability. The mobile workstation can be lighted and heated to further protect the contents such as plans, drawing and documents. The workstation may be rotated to a comfortable working angle and stores flat when not in use. Additionally, the mobile workstation may be mounted on legs to provide a workstation at a jobsite without the vehicle.

### RELATED APPLICATIONS

This application claims priority and herein incorporates by reference U.S. Provisional Patent Application No. 60/595,903, filed Aug. 16, 2005.

### BACKGROUND OF THE INVENTION

Contractors, architects and other professionals often work out of their vehicles when at a job site. This often involves carrying plans and other drawings and papers that must be consulted at the job site regardless of the weather. It is known to use brief cases and covered clipboards and the like to carry these papers and while this method offers some protection from the elements, it is not always practical considering the size of some of the documents that are used. Often such users are forced to lay out the papers on the seat of the vehicle or try to shelter them under a tarp covering the back of a vehicle. This can lead to damaged papers and general disorganization.

To help with this problem, pickup trucks have been equipped with lids or “toppers”, etc. but although these do offer some protection for the materials stored within such devices, they are very inconvenient and do not offer an easily accessible working surface.

There is a need for a work station that is portable and capable of being mounted to a vehicle to provide protection for documents and provide a work surface that allows a user to consult, notate, secure and generally organize the material therein.

### SUMMARY OF THE INVENTION

The present invention is a mobile workstation that is attached to a vehicle such as a pickup truck or SUV. The mobile workstation includes a hinged cover that closes over an inner containment area that is rotatably attached to extruded metal attachment members that can be attached to the vehicle using ratcheting tie-downs. In one embodiment, an attachment platform is attached to the metal attachment members to provide additional stability. The mobile workstation can be lighted and heated to further protect the contents such as plans, drawing and documents. The workstation may be rotated to a comfortable working angle and stores flat when not in use. Additionally, the mobile workstation may be mounted on legs to provide a workstation at a jobsite without the vehicle.

Other features and advantages of the instant invention will become apparent from the following description of the invention which refers to the accompanying drawings.

### BRIEF DESCRIPTION OF THE DRAWINGS

FIG. 1 is a perspective view according to an embodiment of the present invention.

FIG. 2 is a perspective view according to an embodiment of the present invention.

FIG. 3 is a side view according to an embodiment of the present invention.

FIG. 4 is a detailed view of a section shown in FIG. 3

FIG. 5 is a side view of another embodiment according to the present invention.

FIG. 6 is a side view according to an embodiment of the present invention.

FIG. 7 is a side view according to an embodiment of the present invention.

FIG. 8 is a side view according to an embodiment of the present invention.

FIG. 9 is a side view according to an embodiment of the present invention.

FIG. 10 is a side view according to an embodiment of the present invention.

FIG. 11 is a side view of yet another embodiment of the present invention.

FIG. 12 is a top view according to an embodiment of the present invention.

FIG. 13 is a sectional view according to an embodiment of the present invention.

FIG. 14 is a bottom view according to an embodiment of the present invention.

FIG. 15 is a perspective view of another embodiment of the present invention.

FIG. 16 is another perspective view of an embodiment of the present invention.

FIG. 17 is a side view according to an embodiment of the present invention.

FIG. 18 is a side view according to an embodiment of the present invention.

FIG. 19 is a side view according to an embodiment of the present invention.

FIG. 20 is a side view according to an embodiment of the present invention.

### DETAILED DESCRIPTION OF THE INVENTION

Reference is now made to the drawings in which reference numerals refer to like elements.

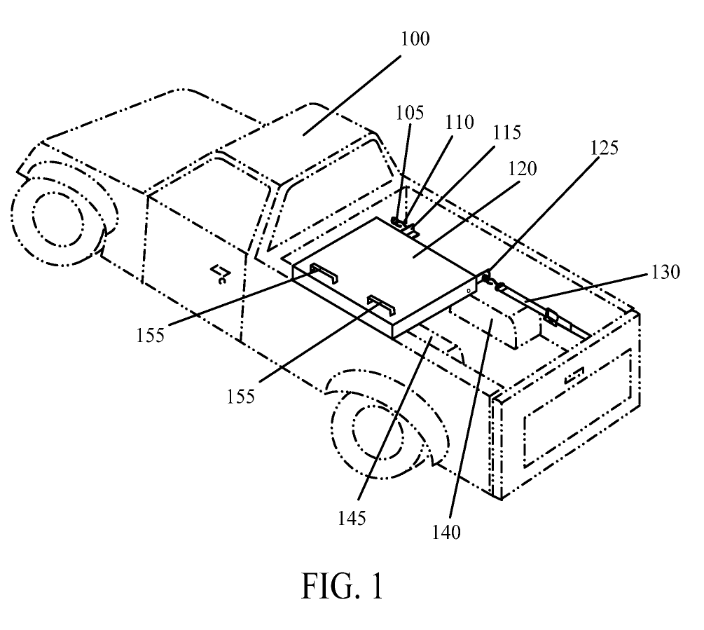

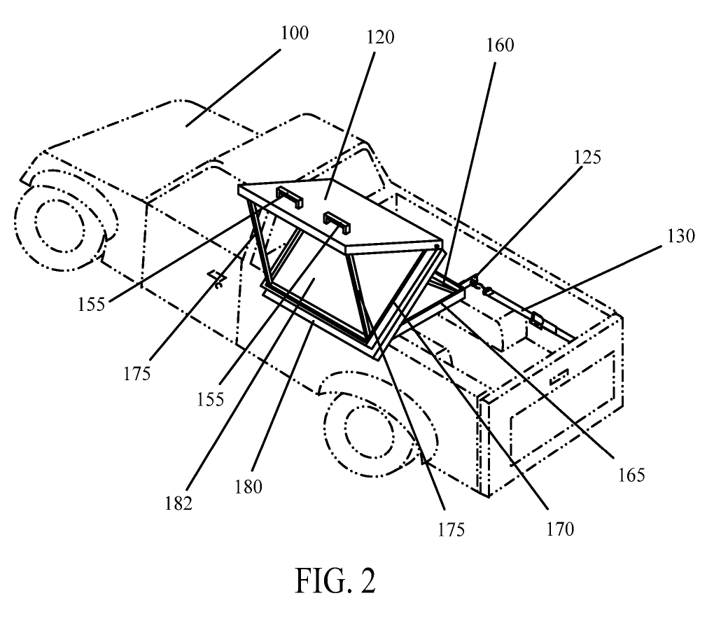

Referring to FIGS. 1 and 2, a mobile workstation is shown having a cover 120, two handles 155, attachment members 115 and 125, a base platform 180, a periphery containment element 170, support rods 175, and two attachment members 115 and 125. The mobile workstation attaches a pickup truck 100 using ratchet tie-downs 130 which are attached to hard points 105 located within the bed of truck 100. A hook 110 connects attachment member 115 to hard point 105. Of course other attachment methods are acceptable to keep the mobile workstation from moving when attached to the vehicle. In the embodiment shown, attachment member 125 rests on left and right well 145 and 140. An attachment platform 165 is used to provide a solid anchoring section for attaching base platform 180 and to provide a storage area for a base support arm 160. In practice, base support arm 160 rotates into place when base platform 180 is raised to a selected working angle. This angle can either be preselected to provide a single operating angle or may be adjustable utilizing different stops (not shown) as is known in the art. Base support arm is a flat sheet of plywood hingedly connected to a bottom of base platform and wedges against a ridge along a trailing edge of attachment platform 165.

Periphery containment element 170 encloses a containment space 182 that is used to hold the materials desired to be protected (not shown). When cover 120 is in a closed position, periphery containment element 170 fit within the edges of cover 120 weather proofing the contents. When cover 120 is rotated to an open position, support rods 175 are placed between cover 120 and base platform 180 to keep cover 10 in an open position. Cover 120 is opened and closed using handles 155.

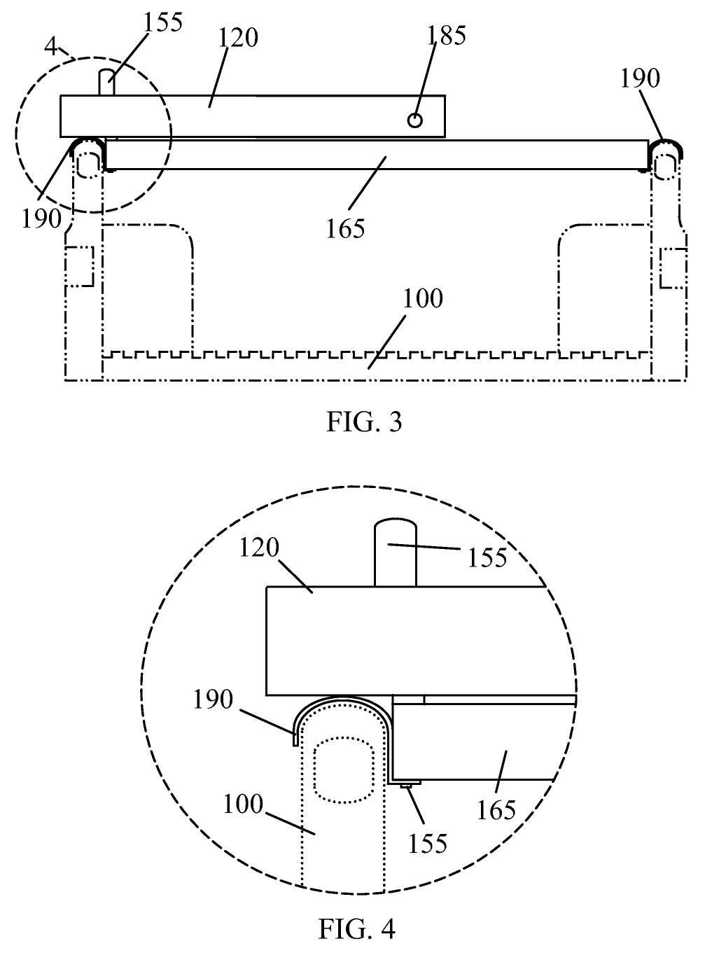

Now referring to FIGS. 3 and 4, an embodiment is shown that does not rely on connecting to hard points. The mobile workstation is shown attached to pickup truck 100 with four mounting brackets 190 (only two are shown) which fit across the top of the side panels of pickup truck 100. Mounting brackets 190 may be bolted to pickup truck 100 (not shown) as is known in the art. Additionally, a rubber like material can be added to the underside surface of mounting brackets 190 to protect the truck bed and to allow the mobile workstation to remain in place without bolting. Additionally, it is possible to make mounting brackets 190 fit within the opening along the top of most pickup truck side panels (not shown). Mounting bracket 190 is attached to attachment platform 165 using bolt 155. Of course other attachment methods may be used such as welding or rivets as is known in the art.

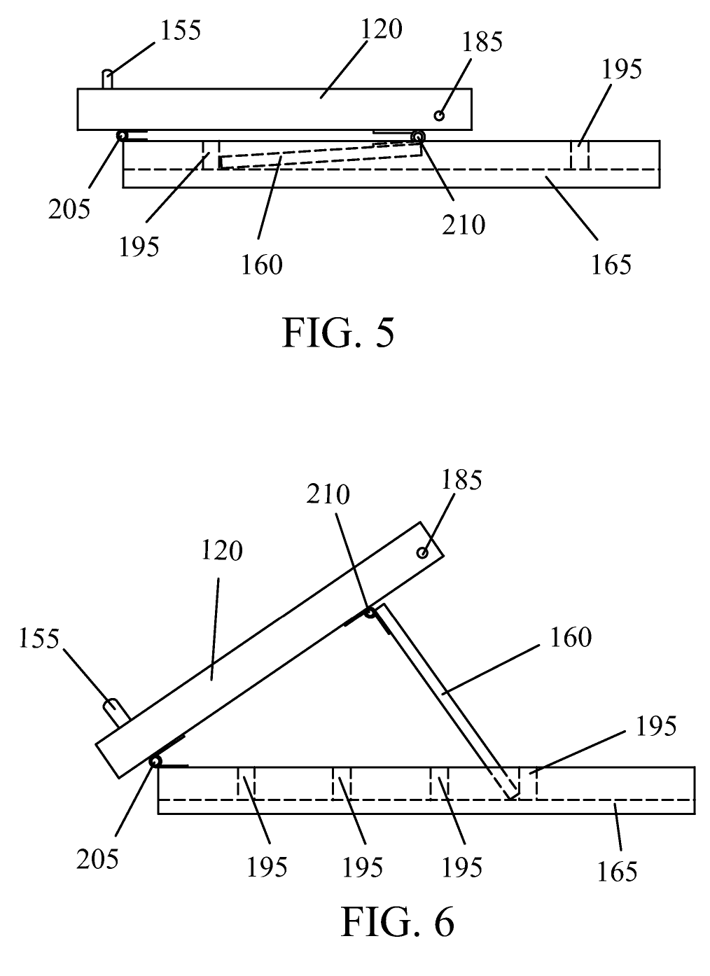

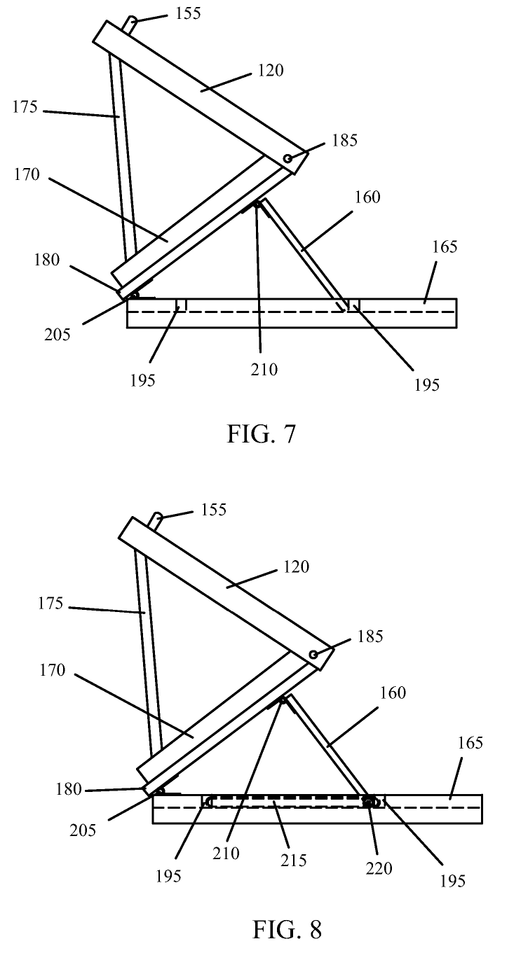

FIGS. 5, 6 and 7 illustrate an embodiment of the present invention in a typical application. Cover 120 is flat in the closed position with base support arm 160 lying within attachment platform 165 and hingedly attached to the bottom of base platform 180 using hinge 210. As base platform 180 is raised for use, base support 160 swings out along attachment platform 165 and is wedged against stop 195. This locks the mobile workstation at the desired angle. In one embodiment, a plurality of stops 195 are provided to enable the user to select from a range of different angles depending on which stop 195 is selected. Base platform rotates into the open position using hinge 205 which is attached to a forward end of attachment platform 165 and the bottom of base platform 180. Next, cover 120 is rotated into the open position using hinge 185. This exposes periphery containment element 170 allowing a user to access the contents. Two support rods 175 are located between cover 120 and base platform 180 to keep cover 120 in the open position for use.

FIG. 8 shows the mobile workstation with a guide track 215 attached to attachment platform 165. Base support arm 160 has a guide wheel 220 that fits within guide track 215 and rolls therein. As base platform 180 rotates, base support arm 160 moves within guide track 215 which has a plurality of rollover stops (not shown) that allow the user to select different operating angles as is known in the art. Of course other kinds of guides can be used such as sliders instead of guide wheels, etc. as is known in the art as long as base support arm is allowed to move from the closed to open position.

FIG. 9 utilizes a pneumatic arm 230 to hold cover 120 in the open position. The advantage of pneumatic arm 230 is that cover 120 may be placed in an infinite number of operating positions. A locking mechanism 225 is disposed on an end of periphery containment element 170 and latches into a catch plate (not shown) located on the inside of cover 120 as is known in the art. Cover 120 is secured using a key to lock locking mechanism 225. Other embodiments are possible such as using a padlock and catch plate and are known in the art.

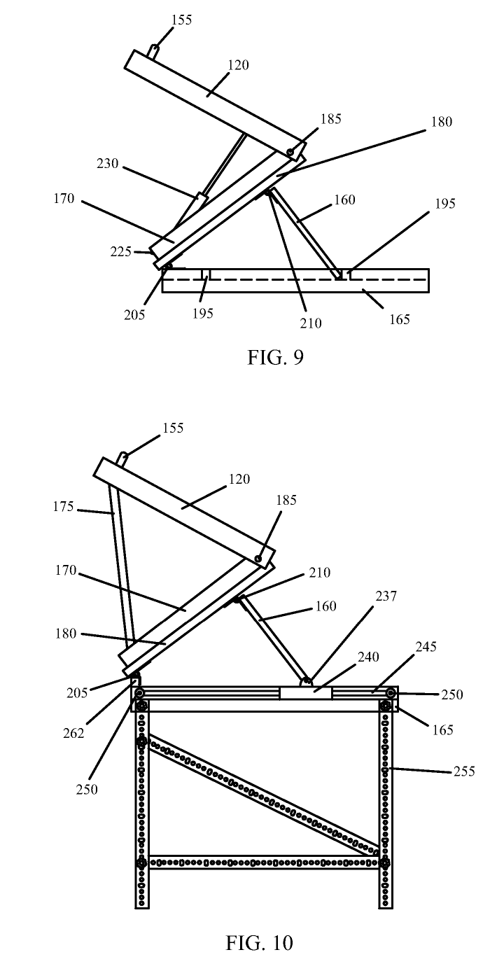

Now referring to FIG. 10, the mobile workstation is shown mounted to a table 255. The mobile workstation could also be placed on any flat surface of sufficient size and strength to support it when a temporary workstation is needed and mobility is not necessary. An alternative embodiment is shown having a slider 240 slidably attached to slide track 245. Slide track 245 is attached to attachment platform 165. Two end stops 250 are located at the ends of slider track 245 to prevent slider 240 from leaving slider track 245. A pivot 237 is provided to connect base support arm 160 to slider 240. As base platform 180 is raised and lowered, base support arm 160 moves along slider track 240 to provide proper positioning. Slider may be frictionally fitted against slider track 245 to provide an infinite number of positioning angles or there may be a plurality of physical stops along slider track 245 to provide a discreet number of positioning angles as is known in the art.

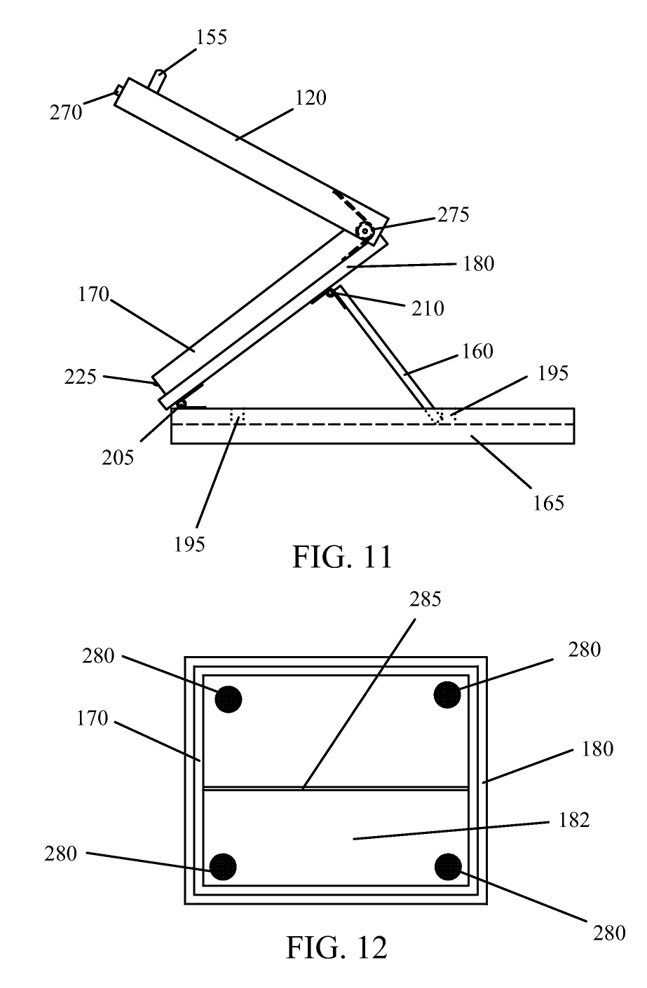

Referring now to FIG. 11, a frictional multi-positional spring 275 is utilized to hingedly attach cover 120 with base platform 180. Multi-positional spring 275 allows cover to be placed in an infinite number of operating angles as is known in the art. Additionally, spring 205 could also be a multi-positional spring eliminating the need for base support arm 160.

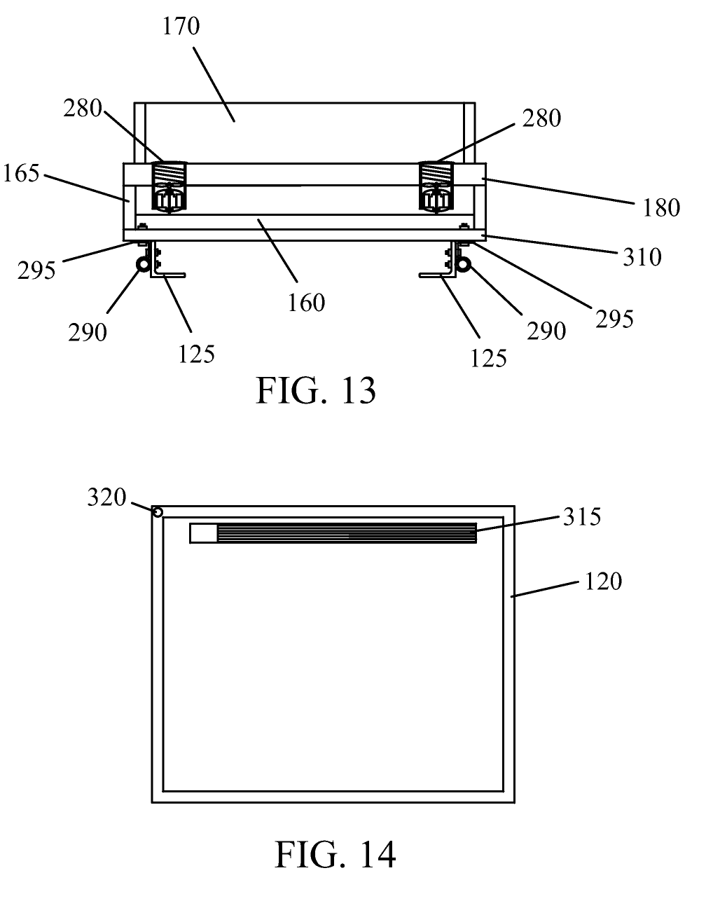

Reference is now made to FIGS. 12 and 13 where the mobile workstation is shown having four heating units 280 disposed within base platform 180 and positioned to heat containment space 182 bounded by periphery containment element 170. A containment restraint 285 stretches from one side of periphery element 170 to an opposite side and is utilized to keep documents and other items from shifting. Containment restraint 285 is a rubber strap but other restraints are acceptable such as elastic belts, plastic leaves etc. as is known in the art. Heating units 280 may be wired with a wiring harness (not shown) to connect to the vehicles electrical system or could be plugged in to a generator or power inverter as is known in the art. In the embodiment shown, attachment member 125 is an extruded metal angle bolted to metal bracket 295 which is also bolted to attachment platform 165. Two attachment eye hooks 290 are provided to attach tie-downs (FIG. 1).

FIG. 14 is a bottom view of cover 120 showing an embodiment equipped with a light 315 and a light switch 320. When cover 120 is in the closed position, light switch 320 makes contact with base platform 180 (FIGS. 2, 7-12) and turns light 315 off. When cover 120 is opened during operation, light switch 320 is activated and light 315 turns on. A fluorescent light is used in this embodiment, but other kinds of lights would work such as low voltage LED's or incandescent as is known in the art. The energy required to operate light 315 could be provided by connecting in to the vehicles electrical system or the light could be battery operated.

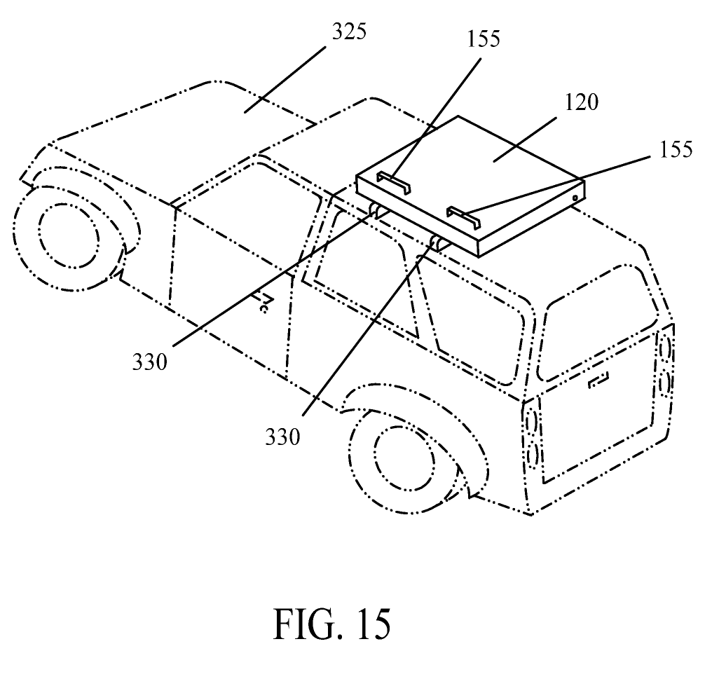

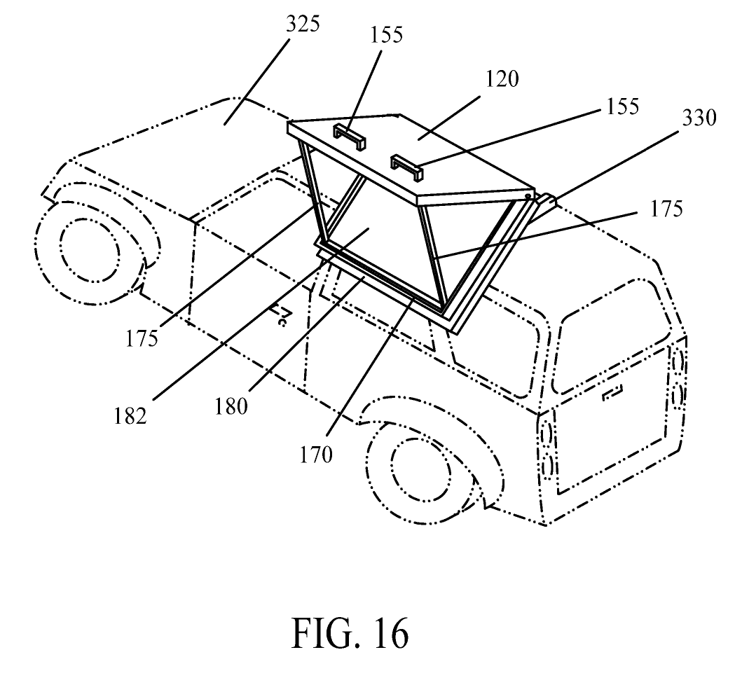

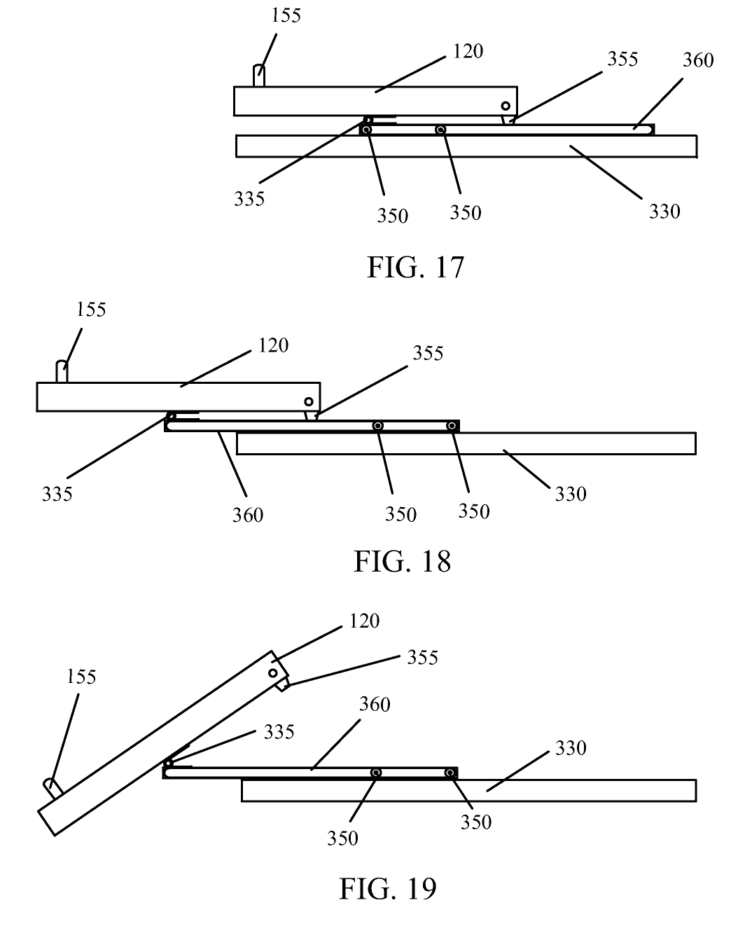

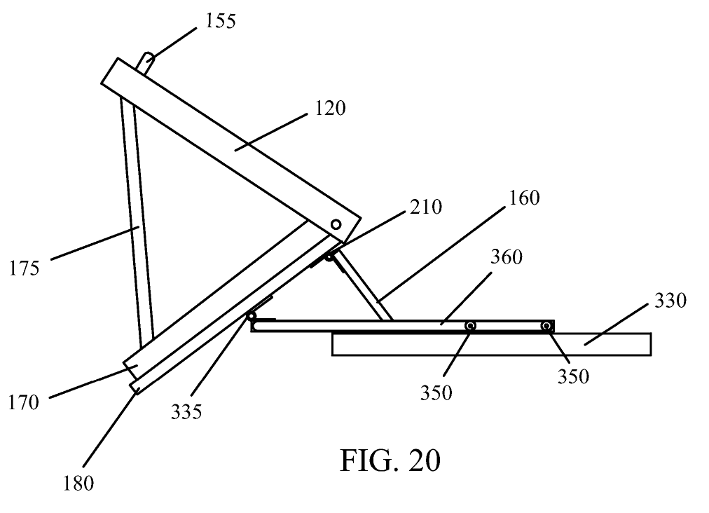

With reference to FIGS. 15 through 20, an embodiment of a mobile workstation adapted for use on the roof of a vehicle such as an SUV 325 is shown having two roof attachment members 330, a slide attachment member 360 attached to each roof attachment member 330, rollers 350, hinge 335 and leveling stop 355. Rollers 350 fit within slide attachment member and allow base platform 180 to slide out past the end of roof attachment members 330 and beyond the edge of the roof of SUV 325. In use, the mobile workstation slides out and then rotates around hinge 335 which is a multi-positional spring allowing base platform to be positioned in an infinite number of operating angles. Alternatively, as shown in FIG. 20, base support arm 160 may be used to provide support for base platform 180 when in use. In this configuration, the bottom of base platform 180 is actually below the level of the roof of SUV 325. Once in position, cover 120 is rotated to an open position and support arm 175 is inserted to keep cover 120 in an open position. When finished, the process is reversed and base platform 180 lies flat and parallel with the roof and the edge does not project out past the edge of the roof. A locking mechanism (not shown) may be used to prevent the workstation from opening or it may simply be secured using a rubber tie-down or bungee cord as is known in the art. Of course this roof-top embodiment may be combined with any of the other embodiments discussed herein and is considered to be part of this disclosure.

Although the instant invention has been described in relation to particular embodiments thereof, many other variations and modifications and other uses will become apparent to those skilled in the art.

What is claimed is:

1. A mobile workstation comprising:
a cover having a forward end and an opposite hinge end;
said cover hingedly attached to a base platform at said opposite hinge end;
said base platform having a hinge end and an opposite end;
said base platform hingedly attached to at least one attachment member at said hinge end;
at least one movable support arm disposed between said cover and said base platform wherein when said cover is in an open condition, said support arm is moved into a position to keep said cover open;
said hinge end rotates in a direction opposite said opposite hinge end; and
at least one movable base support arm disposed between said base platform and said at least one attachment member wherein when said base platform is rotated around said hinge end, said movable base support arm is moved into a position to keep said base platform in an open condition.

2. The mobile workstation according to claim 1 further comprising:
at least one handle disposed on a top portion of said cover; and
a locking mechanism disposed between said cover and said base platform.

3. The mobile workstation according to claim 1 further comprising a light disposed on an inner surface of said cover.

4. The mobile workstation according to claim 1 further comprising at least one mounting bracket attached at an end of said attachment member wherein said mounting bracket fits a sidewall of a pickup truck bed.

5. The mobile workstation according to claim 1 further comprising at least one stop member disposed on an upper surface of said attachment member wherein when said base support arm is rotated into an open position, said base support arm is stopped from further rotation by said stop member.

6. The mobile workstation according to claim 1 further comprising a periphery containment segment disposed on a top surface of said base platform wherein when said cover is closed, said cover closes over said periphery containment segment to weather-proof contents contained therein.

7. The mobile workstation according to claim 1 further comprising a guide track disposed on said attachment member wherein said base support arm moves along said guide track as said base platform moves from a closed and said open position.

8. The mobile workstation according to claim 1 further comprising at least one guide track attached to said attachment member wherein said base support arm is constrained to move within said guide track.

9. The mobile workstation according to claim 1 further comprising a plurality of stops disposed along said attachment member to provide a plurality of different stop positions as base support arm moves from said closed to said open positions.

10. The mobile workstation according to claim 1 wherein said support arm is a pneumatically activated support arm.

11. The mobile workstation according to claim 6 further comprising at least one heating unit disposed within said periphery containment segment wherein said heating unit heats said contents.

12. The mobile workstation according to claim 6 further comprising at least one containment restraint wherein said contents are secured therein.

13. The mobile workstation according to claim 1 wherein said attachment member is made of extruded metal.

14. The mobile workstation according to claim 1 wherein said attachment member is attached to a vehicle using a ratchet tie-down strap.

15. A mobile workstation comprising:
a cover having a forward end and an opposite hinge end;
said cover hingedly attached to a base platform at said opposite hinge end;
said base platform having a hinge end and an opposite end;
said base platform hingedly attached to at least one slide track;
at least one slide track retaining member attached to at least one attachment member wherein said slide track travels within said slide track retaining member allowing said base platform to slide between a deployed position and a stored position;
said hinge end rotating in a direction opposite said opposite hinge end;
a periphery containment segment disposed on a top surface of said base platform wherein when said cover is closed, said cover closes over said periphery containment segment to weather-proof contents contained therein;
at least one cover support means wherein when said cover is in an open condition, said cover support means keeps said cover open; and
at least one base support means wherein when said base platform is rotated around said hinge end, said base support means keeps said base platform in an open condition.

16. The mobile workstation according to claim 15 wherein said cover support means is a multi-positioning spring.

17. The mobile workstation according to claim 15 wherein said base support means is a multi-positioning spring.

18. The mobile workstation according to claim 15 wherein said cover support means is a movable support arm disposed between said cover and said base platform wherein when said cover is in an open condition, said support arm is moved into a position to keep said cover open.

19. The mobile workstation according to claim 15 wherein said base support means is a movable base support arm disposed between said base platform and said at least one attachment member wherein when said base platform is rotated around said hinge end, said movable base support arm is moved into a position to keep said base platform in an open condition.

20. A mobile workstation comprising:
a cover having a forward end and an opposite hinge end;
said cover hingedly attached to a base platform at said opposite hinge end;
said base platform having a hinge end and an opposite end;
said base platform hingedly attached to an attachment platform at said hinge end;
said attachment platform being attached to at least one attachment member;
a periphery containment element disposed on a top surface of said base platform wherein when said cover is closed, said cover closes over said periphery containment segment to weather-proof contents contained therein;
at least one movable support arm disposed between said cover and said base platform wherein when said cover is in an open condition, said support arm is moved into a position to keep said cover open;
said hinge end rotates in a direction opposite said opposite hinge end; and
at least one movable base support arm disposed between said base platform and said attachment platform wherein when said base platform is rotated around said hinge end, said movable base support arm is moved into a position to keep said base platform in an open condition.
